(19) United States
(12) Patent Application Publication
(10) Pub. No.: US 2003/0096197 A1
(43) Pub. Date: May 22, 2003

(54) Method for manufacturing organic electroluminescence device

(76) Inventors: Joo Hyeon Lee, Kyoungki-do (KR); Sun Woong Kim, Seoul (KR); Sung Hoo Ju, Kyoungki-do (KR); Woo Young Kim, Seoul (KR); Won Geon Lee, Seoul (KR)

Correspondence Address: Richard J. Streit, Ladas & Parry, Suite 1200, 224 South Michigan Avenue, Chicago, IL, 60604, US

(21) Appl. No.: 10/272,699

(22) Filed: Oct. 17, 2002

Related U.S. Application Data
(63) Continuation-in-part of application No. 09/599,238, filed on Jun. 22, 2000, now abandoned.

(30) Foreign Application Priority Data
Jun. 25, 1999 (KR) 99-24195

(51) Int. Cl. H01J 1/62

(52) U.S. Cl. 430/318; 430/319; 430/321

(57) ABSTRACT

Disclosed is a method for manufacturing an organic electroluminescence device, which decreases the surface resistance at side edges of pixels and increases the uniformity of the pixels, thereby reducing degradation of the device, increasing the life of the device, and improving the displaying sharpness of the device. According to the method, at first, a transparent metal film is deposited on a transparent substrate. Then, the transparent metal film is wet-etched to form anodes respectively having a transverse section whose side profiles are tapered at an angle between 70 and 90 degrees. Thereafter, an organic layer is formed on the anodes and on the substrate, and then cathodes are formed on the organic layer.

### RELATED U.S. APPLICATION DATA

This application is a Continuation-in-Part of application Ser. No. 09/599,238 filed Jun. 22, 2000.

### BACKGROUND OF THE INVENTION

1. Field of the Invention

The present invention relates to a method for manufacturing an organic electroluminescence device, which decreases the surface resistance at side edges of pixels and increases the uniformity of the pixels, thereby reducing degradation of the device, increasing the life of the device, and improving the displaying sharpness of the device.

2. Description of the Related Art

An organic electroluminescence device is a next generation image display device, which is employed in a cellular-phone, a car navigation system (CNS), a display panel of a game machine, a notebook computer, a wall-mounted type television, etc.

Referring to FIG. 1 showing a conventional organic electroluminescence device, anodes 11 extending in parallel in a predetermined direction are formed on a transparent substrate 10 such as a glass. Each of the anodes 11 has a section whose side profiles are tapered at predetermined angles. An organic layer 12 is formed on the anodes 11 and on the entire substrate 10. In this case, the anodes 11 perform a function of supplying holes, and are formed by means of an indium tin oxide (hereinafter, ITO) film having a superior light-transmittivity and a superior electric-conductivity, so that the light emitted from the organic layer 12 can transmit through the anodes 11. Further, though not shown, the organic layer 22 includes a hole-carrying layer, a light-emitting layer, and an electron-carrying layer. A plurality of cathodes 13 opposed to the anodes 11 are formed on the organic layer 12. The cathodes 13 extend crossing over the anodes 11, so that the cathodes 13 together with the anodes 11 form a shape of a matrix. In this case, the cathodes 13 perform a function of supplying the electrons, and are made from metal having a low work function and a high stability in order to ensure a smooth supply of the electrons.

That is, in the organic electroluminescence device as described above, light is emitted and transmitted from the organic layer 12 between the anodes 11 and the cathodes 13 by the voltage applied between the anodes 11 and the cathodes 13.

In the meantime, due to the tapered side profiles of the anodes 11, each of the anodes 11 has a relatively uniform surface resistance at the middle portion thereof, while having a surface resistance increasing as it goes toward both side edges of each of the anodes 11. Accordingly, when the driving voltage is applied, center portions of pixels or picture elements, at which the anodes 11 and the cathodes cross over each other, begin to emit light at a relatively low voltage, while edges of the pixels emit light at a relatively high voltage. Therefore, not only the displaying sharpness is deteriorated, but also it is impossible to operate the device for a relatively long time because the side edges of the pixels are degraded when the driving voltage is elevated.

### SUMMARY OF THE INVENTION

Accordingly, the present invention has been made in an effort to solve the problems occurring in the related art, and it is an object of the present invention to provide a method for manufacturing an organic electroluminescence device, which decreases the surface resistance at side edges of pixels and increases the uniformity of the pixels, thereby reducing degradation of the device, increasing the life of the device, and improving the displaying sharpness of the device.

In accordance with one aspect of the present invention, there is provided a method for manufacturing an organic electroluminescence device, the method comprising the steps of:

depositing a transparent metal film on a transparent substrate;

wet-etching the transparent metal film to form anodes respectively having a transverse section whose side profiles are tapered at an angle between 70 and 90 degrees;

forming an organic layer on the anodes and on the substrate; and

forming cathodes on the organic layer.

Preferably, the anodes are respectively formed to have a transverse section whose side profiles are vertical, in the wet-etching step. More preferably, the transparent metal film is an indium tin oxide film.

In accordance with another aspect of the present invention, there is provided a method for manufacturing an organic electroluminescence device, the method comprising the steps of:

preparing a transparent substrate on which anodes are formed by patterning a transparent metal film, the anodes respectively having a transverse section whose side profiles are tapered at predetermined angles;

forming a dielectric film on the anodes and on the transparent substrate, in such a manner that center portions of the anodes are exposed through the dielectric film;

forming black matrices on the dielectric film, in such a manner that center portions of the anodes are exposed through the black matrices;

forming organic layers on the center portions of the anodes; and

forming cathodes on the black matrices and the organic layers.

Preferably, the dielectric film is an oxide film selected from the group consisting of a BaO film, a Y₂O₃ film, an SiO₂ film, an SiON film, and an SiNx film.

Also, it is preferred that the black matrices are opaque metal films selected from the group consisting of chrome (Cr) films and copper (Cu) films.

More preferably, the dielectric film is formed by a first shadow mask, by which the center portions of the anodes are masked, and through which edges of the anodes and the substrate are exposed. The black matrices may be formed also by the first shadow mask, by which the center portions of the anodes are masked, and through which the dielectric film is exposed.

In this case, the dielectric film and the black matrices are formed by a photolithography and an etching. Also, the organic layers are formed by a second shadow mask, through which the center portions of the anodes are exposed, and by which the black matrices are masked. The anodes may be formed by patterning an indium tin oxide film.

### BRIEF DESCRIPTION OF THE DRAWINGS

The above objects, and other features and advantages of the present invention will become more apparent after a reading of the following detailed description when taken in conjunction with the drawings, in which:

FIG. 1 is a sectional view of a conventional organic electroluminescence device;

FIGS. 2A to 2C are sectional views for describing a method for manufacturing an organic electroluminescence device according to an embodiment of the present invention; and

FIGS. 3A to 3E are sectional views for describing a method for manufacturing an organic electroluminescence device ccording to another embodiment of the present invention.

### DETAILED DESCRIPTION OF PREFERRED EMBODIMENTS

The above and other objects, characteristics, and advantages of the present invention will become apparent from the following description along with the accompanying drawings.

Hereinafter, described in detail will be several preferred embodiments of the present invention, with reference to the accompanying drawings. In the following description and drawings, the like parts having the same function will be designated by the same numerals, and repetition of the same description will be avoided.

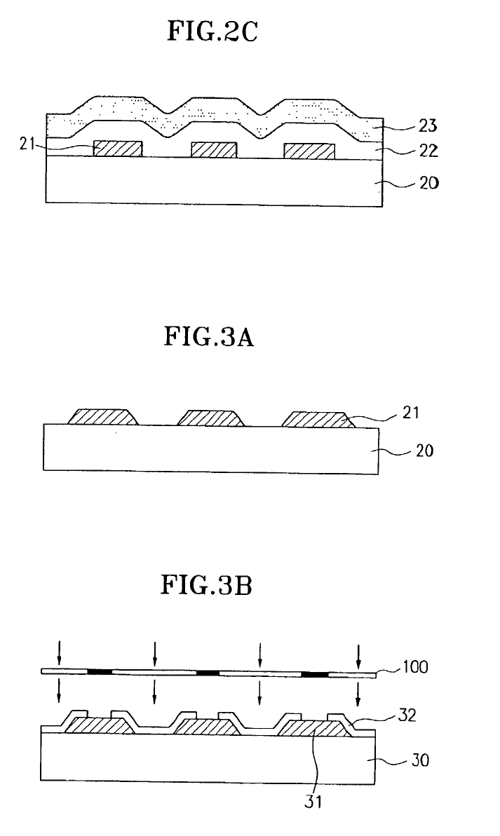

FIGS. 2A to 2C are sectional views for describing a method for manufacturing an organic electroluminescence device according to an embodiment of the present invention.

Referring to FIG. 2A, a transparent metal film such as an ITO film is deposited on a transparent substrate 20 such as a glass, and a photo-resist pattern (not shown) is formed thereon by a photolithography. Thereafter, the ITO film is etched by a wet etching by utilizing the photo-resist pattern as a shadow mask, so as to form a plurality of anodes 21 extending in parallel in a predetermined direction and being spaced at predetermined intervals. The anodes 21 respectively has a section whose side profiles are nearly vertical, for example, tapered at about 70 to 90 degrees. In this case, the wet etching should be carefully performed, so as not to be excessively etched.

The surface resistance of the anodes is in the range of 3 to 20Ω/□, wherein the surface resistance depends on the thickness of ITO film. For example, when the ITO film has a thickness of 2000 Å, the surface resistance is 8Ω/□. In this case, light emitted from each pixel becomes uniform and the generation of shorts can be prevented.

Referring to FIG. 2B, an organic layer 22 is formed on the anodes 21 and on the entire substrate 20. The organic layer 22 includes a hole-carrying layer, a light-emitting layer, and an electron-carrying layer, though not shown in the drawing.

Referring to FIG. 2C, a metal film is deposited on the organic layer 22, and then is patterned so as to form a plurality of cathodes 23 on the organic layer 22, which are opposed to the anodes 21. The cathodes 23 extend crossing over the anodes 21, so that the cathodes 23 together with the anodes 21 make a shape of a matrix. In this case, the metal film has a low work function and a high stability.

In other words, since the anodes 21 respectively have vertical side profiles, the pixels respectively have a uniform surface resistance at both the center portion and the side edges of each pixel. Therefore, the center portion and the side edges of each pixel emit light at the same driving voltage, thereby improving the sharpness of display and preventing the degradation of the side edges of each pixel.

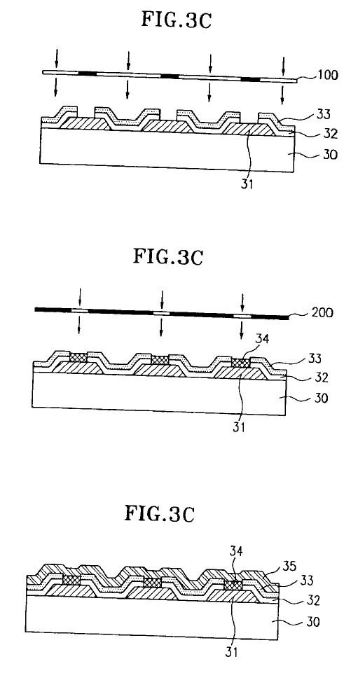

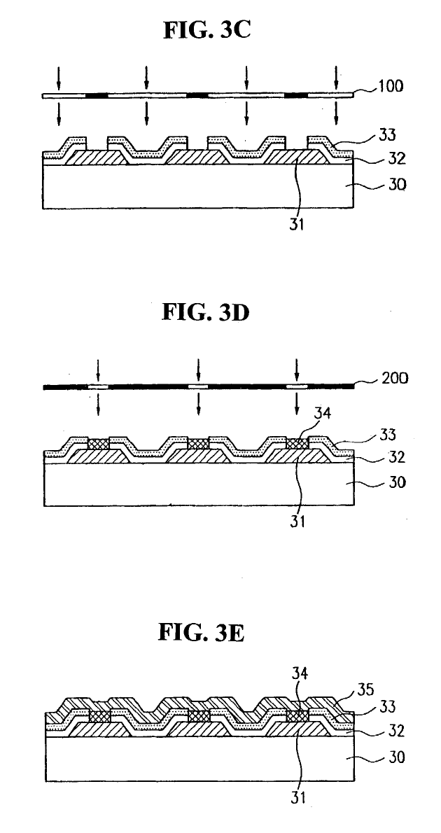

FIGS. 3A to 3E are sectional views for describing a method for manufacturing an organic electroluminescence device according to another embodiment of the present invention.

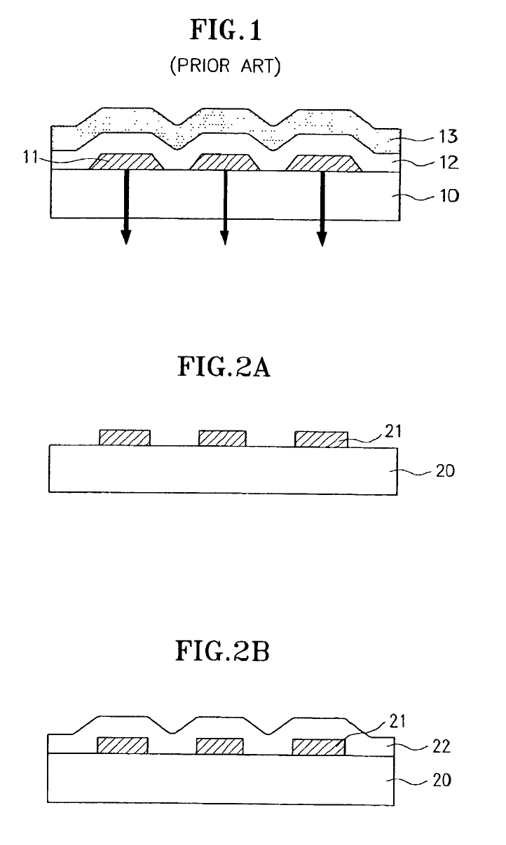

Referring to FIG. 3A, a transparent metal film such as an ITO film is deposited on a transparent substrate 30 such as a glass, and a plurality of anodes 31 are formed by patterning the metal film through a photolithography and an etching. The anodes 31 extend in parallel in a predetermined direction and are spaced at predetermined intervals. The anodes 31 respectively have a section whose side profiles are tapered at predetermined angles as those in the prior art shown in FIG. 1.

The surface resistance of the anodes is in the range of 3 to 20Ω/□, wherein the surface resistance depends on the thickness of ITO film. For example, when the ITO film has a thickness of 2000 Å, the surface resistance is 8Ω/□. In this case, light emitted from each pixel becomes uniform and the generation of shorts can be prevented.

As shown in FIG. 3B, disposed above the anodes 31 is a first shadow mask 100, by which center portions of the anodes 31 are masked, and through which side edges of the anodes 31 and the substrate 30 are exposed. Then, a dielectric film 32 having holes is formed thereon by means of the first shadow mask 100, so that the center portions of the anodes 31 are exposed through the holes of the dielectric film 32. Preferably, the dielectric film 32 is formed as an oxide film such as a BaO film, a Y₂O₃ film, an SiO₂ film, an SiON film, and an SiNx film. Thereafter, as shown in FIG. 3C, black matrices 33 are formed on the dielectric film 32 by means of the first shadow mask 100. Preferably, the black matrices 33 are formed as opaque metal films such as Cr films and Cu films. Also, the dielectric film 32 and the black matrices 33 may be formed by a photolithography and an etching.

As shown in FIG. 3D, disposed above the black matrices 33 is a second shadow mask 200, by which center portions of the anodes 31 are exposed, and through which the black matrices 33 are masked. Then, organic layers 34 are formed on the center portions of the anodes 31 by means of the second shadow mask 200. In this case, though not shown, each of the organic layers 34 includes a hole-carrying layer, a light-emitting layer, and an electron-carrying layer. By the above construction, light is emitted from center portions of the pixels by the organic layers 34 formed only at the center portions of the anodes 31, while the black matrices 33 block off the light above the side edges of the anodes 31, so that the sharpness of display is improved and a degradation of edges of the pixels is prevented.

Thereafter, as shown in FIG. 3E, a plurality of cathodes 35 opposed to the anodes 31 are formed on the organic layers 34 and the black matrices 33. The cathodes 35 extend crossing over the anodes 31, so that the cathodes 35 together with the anodes 31 make a shape of a matrix. In this case, the cathodes 35 are formed by means of a third shadow mask for cathodes or by a photolithography and an etching.

In the method for manufacturing an organic electroluminescence device according to the present invention as described above, the anodes are formed to have vertical side profiles, so that the surface resistance is constant both at the center portions and at the side edges of the pixels. In this case, a simultaneous light-emitting from the entire portions of the pixels at the same driving voltage is enabled. According to another aspect of the present invention, the light toward the side edges of the anodes is blocked off, so that only the center portions of the pixels emit light. Therefore, the present invention not only improves the sharpness of display, but also prevents degradation of the side edges of the pixels of the organic electroluminescence device.

As described above, in the present invention, the taper angle of anodes is in the range of 70 to 90°, thereby improving the uniformity light emission. And, the surface resistance of anodes is in the range of 3 to 20Ω/□, thereby the light emitted from each pixel becomes uniform and the generation of shorts can be prevented.

While there have been illustrated and described what are considered to be preferred specific embodiments of the present invention, it will be understood by those skilled in the art that the present invention is not limited to the specific embodiments thereof, and various changes and modifications and equivalents may be substituted for elements thereof without departing from the true scope of the present invention.

What is claimed is:

1. A method for manufacturing an organic field electroluminescence device, the method comprising the steps of:
depositing a transparent metal film on a transparent substrate;
wet-etching the transparent metal film to form anodes respectively having a transverse section whose side profiles are tapered at an angle between 70 and 90 degrees;
forming an organic layer on the anodes and on the substrate; and
forming cathodes on the organic layer.

2. A method as claimed in claim 1, wherein the anodes are respectively formed to have a transverse section whose side profiles are vertical, in the wet-etching step.

3. A method as claimed in claim 1, wherein the transparent metal film is an indium tin oxide film,

4. A method as claimed in claim 3, wherein the indium tin oxide film has a thickness of 2000 Å, the surface resistance is 8Ω/□.

5. A method as claimed in claim 1, wherein said cathodes formed on said organic layer are opposed to said anodes so that said cathodes together with said anodes make a shape of a matrix.

6. A method as claimed in claim 1, wherein the surface resistance of the anodes is in the range of 3 to 20Ω/□.

7. A method for manufacturing an organic electroluminescence device, the method comprising the steps of:
preparing a transparent substrate on which anodes are formed by patterning a transparent metal film, the anodes respectively having a transverse section whose side profiles are tapered at predetermined angles;
forming a dielectric film on the anodes and on the transparent substrate, in such a manner that center portions of the anodes are exposed through the dielectric film;
forming black matrices on the dielectric film, in such a manner that center portions of the anodes are exposed through the black matrices;
forming organic layers on the center portions of the anodes; and
forming cathodes on the black matrices and the organic layers.

8. A method as claimed in claim 7, wherein the dielectric film is an oxide film selected from the group consisting of a BaO film, a Y₂O₃ film, an SiO₂ film, an SiON film, and an SiNx film.

9. A method as claimed in claim 7, wherein the black matrices are opaque metal films selected from the group consisting of chrome (Cr) films and copper (Cu) films.

10. A method as claimed in claim 7, wherein the dielectric film is formed by a first shadow mask, by which the center portions of the anodes are masked, and through which edges of the anodes and the substrate are exposed.

11. A method as claimed in claim 7, wherein the black matrices are formed by the first shadow mask, by which the center portions of the anodes are masked, and through which the dielectric film is exposed.

12. A method as claimed in claim 7, wherein the dielectric film and the black matrices are formed by a photolithography and an etching.

13. A method as claimed in claim 7, wherein the organic layers are formed by a second shadow mask, through which the center portions of the anodes are exposed, and by which the black matrices are masked.

14. A method as claimed in claim 7, wherein the anodes are formed by patterning an indium tin oxide film.

15. A method for manufacturing an organic electroluminescence device, the method comprising the steps of:
depositing a transparent metal film on a transparent substrate;
wet-etching the transparent metal film to form anodes respectively having a transverse section whose side profiles are tapered at an angle between 70 and 90 degrees;
forming an organic layer on the anodes and on the substrate; and
forming cathodes on the organic layer,
wherein the surface resistance of the anodes is in the range of 3 to 20Ω/□.
